(19) United States
(12) Patent Application Publication
(10) Pub. No.: US 2025/0122340 A1
(43) Pub. Date: Apr. 17, 2025

(54) POLYETHERIMIDE HAVING METAL-SUBSTITUTED ANIONIC PENDANT GROUPS

(71) Applicant: SHPP GLOBAL TECHNOLOGIES B.V., Bergen op Zoom (NL)

(72) Inventors: Roy Ray Odle, Mt. Vernon, IN (US); Clay Bradley Arrington, Gilbert, AZ (US); Timothy Edward Long, Blacksburg, VA (US)

(21) Appl. No.: 18/717,814

(22) PCT Filed: Dec. 9, 2022
(86) PCT No.: PCT/IB2022/062008

§ 371 Date: Jun. 7, 2024

(30) Foreign Application Priority Data
Dec. 9, 2021 (EP) 21213481.1

(51) Int. Cl. C08G 73/10; C08L 79/08

(52) U.S. Cl. CPC C08G 73/1064; C08G 73/1028; C08L 79/08; C08L 2205/025

(57) ABSTRACT

A polyimide, comprising 1-100 mol % of repeating units of formula (1), based on 100 mol % of total repeating units of the polyimide, wherein each V is as defined herein; and each R¹ is independently a divalent group of formula (3), wherein A is anionic, and each A is independently —O, —S, —S(O)₂, —S(O)₂O, —OS(O)₂O, —OP(O) (OR)^{d}O, —P(O)(R^{e})O, —P(O)(OR^{f})O, or —OP(O)(R^{g})O; and X is cationic, and each X is independently Li, Na, K, Cs, Mg, Ca, Sr, Cr, Mn, Fe, Co, Ni, Cu, Ag, Zn, Cd, B, Al, Ga, In, Ge, Sn, Pb, As, Sb, phosphonium, imidazolium, guanidinium, or pyridinium; and R^{d}, R^{e}, R^{f}, and R^{g} are each independently hydrogen, substituted or unsubstituted C₁₋₈ alkyl, or substituted or unsubstituted C₆₋₁₂ aryl.

### CROSS REFERENCE TO RELATED APPLICATION

This application claims priority to European Application No. 21213481.1, filed on Dec. 9, 2021, the content of which is incorporated by reference in its entirety.

### BACKGROUND

Polyimides (PIs) and polyetherimides (PEIs) are amorphous, transparent, high performance polymers having a high glass transition temperature. Polyetherimides further have high strength, heat resistance, and modulus, and broad chemical resistance, and thus are widely used in applications as diverse as automotive, telecommunication, aerospace, electrical/electronics, transportation, and healthcare. Moreover, PEIs can be recycled, whereas some PIs are thermosets that cannot be recycled.

Accordingly, there remains a continuing need for thermoplastic polyimides and polyetherimides that have high thermal stability and superior mechanical properties.

### SUMMARY

Provided is a polyimide including 1 to 100 mol %, or 1 to 99 mol %, or 1 to 50 mol %, or 1 to 25 mol %, or 1 to 15 mol % of repeating units of formula (1), based on 100 mol % of total repeating units of the polyimide:

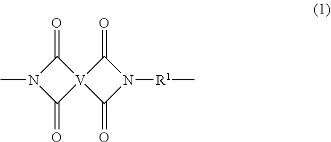

wherein each V is independently a group of formulae:

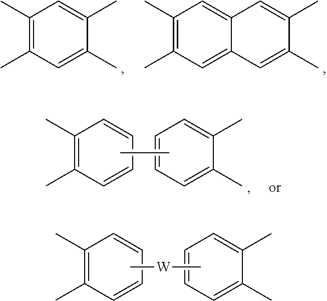

wherein W is —O—, —S—, —C(O)—, —SO₂—, —SO—, —P(R^{c})(═O)— wherein R^{c} is a C₁₋₈ alkyl or C₆₋₁₂ aryl, —C_{y}H_{2y}— wherein y is an integer from 1 to 5 or a halogenated derivative thereof, or a group of the formula —O—Z—O— wherein Z is an aromatic C₆₋₂₄ monocyclic or polycyclic moiety optionally substituted with 1 to 6 heteroatoms, 1 to 8 halogen atoms, or a combination thereof, provided that the valence of Z is not exceeded; and each R¹ is independently a divalent group of formula (3):

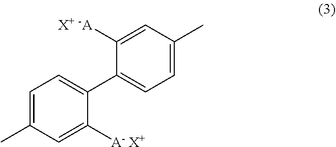

wherein A is anionic, and each A is independently —O, —S, —S(O)₂, —S(O)₂O, —OS(O)₂O, —OP(O)(OR^{d})O, —P(O)(R^{e})O, —P(O)(OR^{f})O, or —OP(O)(R^{g})O; X is cationic, and each X is independently Li, Na, K, Cs, Mg, Ca, Sr, Cr, Mn, Fe, Co, Ni, Cu, Ag, Zn, Cd, B, Al, Ga, In, Ge, Sn, Pb, As, Sb, phosphonium, imidazolium, guanidinium, or pyridinium, and R^{d}, R^{e}, R^{f}, and R^{g} are each independently hydrogen, substituted or unsubstituted C₁₋₈ alkyl, or substituted or unsubstituted C₆₋₁₂ aryl, optionally, wherein the polyimide includes at least one endcap derived from an endcapping agent.

Also provided is a method for the manufacture of the polyimide, wherein the polyimide is a polyimide copolymer, wherein the method includes reacting a dianhydride of formula (5):

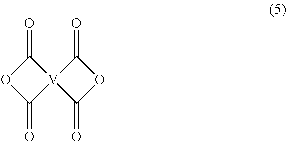

or a chemical equivalent thereof, with a diamine of formula (6), and, optionally, a diamine of formula (7):

H₂N—R¹—NH₂ (6)

H₂N—R²—NH₂ (7)

in a solvent and under conditions effective to provide the polyimide, wherein V, R¹, and R² are as defined herein, and wherein each V in the repeating units of formula (5) is the same as each V in the repeating units of formula (1).

Another aspect provides a method for the manufacture of a polyimide, wherein the polyimide is a polyetherimide, wherein the method includes reacting a dianhydride of formula (5a):

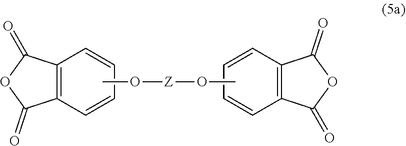

with a diamine of formula (6), and, optionally, a diamine of formula (7):

H₂N—R¹—NH₂ (6)

H₂N—R²—NH₂ (7)

in a solvent and under conditions effective to provide the polyetherimide, wherein R¹ and R² are as defined herein, and wherein each Z in the repeating units of formula (5a) is the same as each Z in the repeating units of formula (2a).

Still another aspect provides a poly(amic acid) solution including 1 to 99 weight percent, or 10 to 90 weight percent, or 0.1 to 20 weight percent, or 0.5 to 10 weight percent, or 1 to 5 weight percent of a poly(amic acid) derived from the dianhydride of formula (5), the diamine of formula (6), and optionally the diamine of formula (7); and a solvent, wherein the dianhydride of formula (5), the diamine of formula (6), and the diamine of formula (7) are as defined herein.

Also provided is a polymer composition including the polyimide as defined herein; and a second polyimide different from the polyimide, wherein the second polyimide comprises repeating units represented by formula (2′):

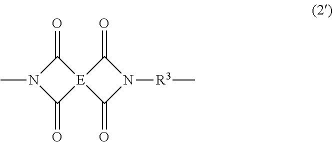

wherein each E is independently a tetravalent C₄₋₄₀ hydrocarbon group, optionally comprising 1 to 3 heteroatoms, and each R³ is independently a C₁₋₃₀ divalent hydrocarbon group, optionally comprising 1 to 4 heteroatoms. In some aspects, each E is independently a tetravalent C₄₋₄₀ hydrocarbon group, optionally comprising 1 to 2 heteroatoms, and each R³ is independently a C₁₋₃₀ divalent hydrocarbon group, optionally comprising 1 to 2 heteroatoms. In some aspects, each E is independently a tetravalent C₄₋₄₀ hydrocarbon group, optionally comprising 1 heteroatom, and each R³ is independently a C₁₋₃₀ divalent hydrocarbon group, optionally comprising 1 heteroatom. In some aspects, E is independently a tetravalent C₄₋₄₀ hydrocarbon group and each R³ is independently a C₁₋₃₀ divalent hydrocarbon group, wherein optional heteroatoms are not present.

Another aspect provides an article including the polyimide as defined herein, preferably wherein the article is a film, a membrane, a fiber, a foam, a sheet, a conductive part, a coating, a preform, a composite, a varnish, or a lens; or wherein the article is an open cell foam, a closed cell foam, a nano-foam, a battery separator, an ion exchange membrane, tubing, a capillary, or a scratch resistant part; or wherein the article is a separator for a secondary battery.

### BRIEF DESCRIPTION OF THE DRAWINGS

The following is a brief description of the drawings wherein like elements are numbered alike and which are exemplary of the various aspects described herein.

FIG. 1 is a graph of ionic conductivity (Siemens per inverse centimeter (S cm⁻¹)) versus amount of BDSA-Na (mole percent, mol %) in accordance with one or more aspects described herein.

### DETAILED DESCRIPTION

Excellent thermal stability, good chemical resistance, high tensile strength, and electrical insulation are desirable characteristics of high-performance polymers for use in, for example, aviation and aerospace industries. However, few high-performance polymers exhibit water solubility or can be prepared from precursors that may be processed in water. Commonly, incorporation of ionic functionalities onto polymeric backbones enables loading of highly aromatic polymers into water. Likewise, introduction of ionic groups provides physical crosslinking of polymeric systems, increasing chain rigidity and improving glass transition temperatures. Preparation of polyetherimides with tunable hydrophilicity and mechanical properties via installation of ionic functionalities could be advantageous for use as battery separators and other thin film applications. Likewise, blending of such polyimides bearing ionic groups with a second, non-functionalized polyimide may provide phase separated materials for electrical applications.

Provided is a polyimide including repeating units of formula (1)

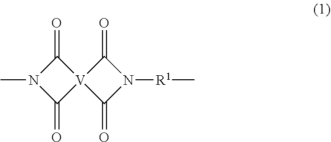

wherein each V is independently a group of formulas:

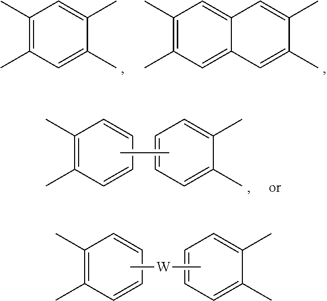

wherein W is —O—, —S—, —C(O)—, —SO₂—, —SO—, —P(R^{h})(═O)— wherein R^{h} is a C₁₋₈ alkyl or C₆₋₁₂ aryl, —C_{y}H_{2y}— wherein y is an integer from 1 to 5 or a halogenated derivative thereof (which includes perfluoroalkylene groups), or a group of the formula —O—Z—O— wherein Z is an aromatic C₆₋₂₄ monocyclic or polycyclic moiety optionally substituted with 1 to 6 heteroatoms, 1 to 8 halogen atoms, or a combination thereof, provided that the valence of Z is not exceeded.

In formula (1), each R¹ is independently a divalent group of formula (3)

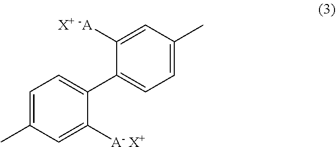

wherein, in formula (3), A is anionic, and each A is independently —O, —S, —S(O)₂, —S(O)₂O, —OS(O)₂O, —OP(O)(OR^{d})O, —P(O)(R^{e})O, —P(O)(OR^{f})O, or —OP(O)(R^{g})O, wherein R^{d}, R^{e}, R^{f}, and R^{g} are each independently hydrogen, substituted or unsubstituted C₁₋₈ alkyl, or substituted or unsubstituted C₆₋₁₂ aryl. X is cationic, and each X is independently Li, Na, K, Cs, Mg, Ca, Sr, Cr, Mn, Fe, Co, Ni, Cu, Ag, Zn, Cd, B, Al, Ga, In, Ge, Sn, Pb, As, Sb, phosphonium, imidazolium, guanidinium, or pyridinium.

For example, each R¹ of the polyimide of formula (1) can include a group represented by formula (3a):

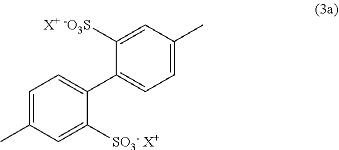

wherein each X is Li, Na, K, Cs, Mg, Ca, Sr, Zn, phosphonium, imidazolium, guanidinium, pyridinium, or a combination thereof. Preferably, X is Li, Na, K, Cs, or a combination thereof.

For convenience, the bonding between cationic group X⁺ and anionic group A⁻ is an ionic bond that can be depicted as charge-neutral compound such as -A-X. It is understood that this expression is equivalent to X⁺ and A⁻ each having a formal charge. For example, when A is —S(O)₂O, it is understood that —S(O)₂O is an anionic group having a −1 charge. Accordingly, in an exemplary polyimide wherein X is phosphonium and A is S(O)₂O, the bond A-X is an ionic bond and can be represented as X—O(O)₂S—, which is equivalent to the cation-anion complex —[X]⁺[O(O)₂S]⁻.

The polyimide can be homopolymer or a copolymer having repeating units different from formula (1). When the polyimide is a copolymer, the polyimide can include 1 to 100 mole percent (mol %), 1 to 99 mol %, or 1 to 50 mol %, or 1 to 25 mol %, or 1 to 15 mol % of repeating units of formula (1), based on 100 mol % of total repeating units of the polyimide. In other aspects, the polyimide can include 5 to 100 mol %, or 25 to 100 mol %, or 50 to 100 mol % of repeating units of formula (1), based on 100 mol % of total repeating units of the polyimide.

For example, the polyimide can further include 1 to 99 mol %, or 1 to 95 mol %, or 10 to 90 mol %, or 25 to 85 mol %, or 50 to 75 mol % of repeating units of formula (2), based on 100 mol % of total repeating units of the polyimide:

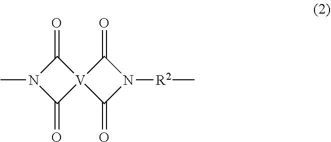

wherein each V is independently a tetravalent C₄₋₄₀ hydrocarbon group, optionally comprising 1 to 3 heteroatoms; such as a C₆₋₂₀ aromatic hydrocarbon group. Exemplary tetravalent groups are described above. Each V in the repeating units of formula (1) can be the same as or different than each V in the repeating units of formula (2). Preferably, V is the same in the repeating units of formula (1) and formula (2) of the polyimide.

In formula (2), each R² is independently a C₁₋₃₀ divalent hydrocarbon group, optionally comprising 1 to 4 heteroatoms, or 1 to 3 heteroatoms, or 1 to 2 heteroatoms, or 1 heteroatom. In some aspects, R² is independently a C₁₋₃₀ divalent hydrocarbon group, wherein optional heteroatoms are excluded. For example, each R² is the same or different C₆₋₃₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof. Exemplary C₁₋₃₀ divalent hydrocarbon groups include the following:

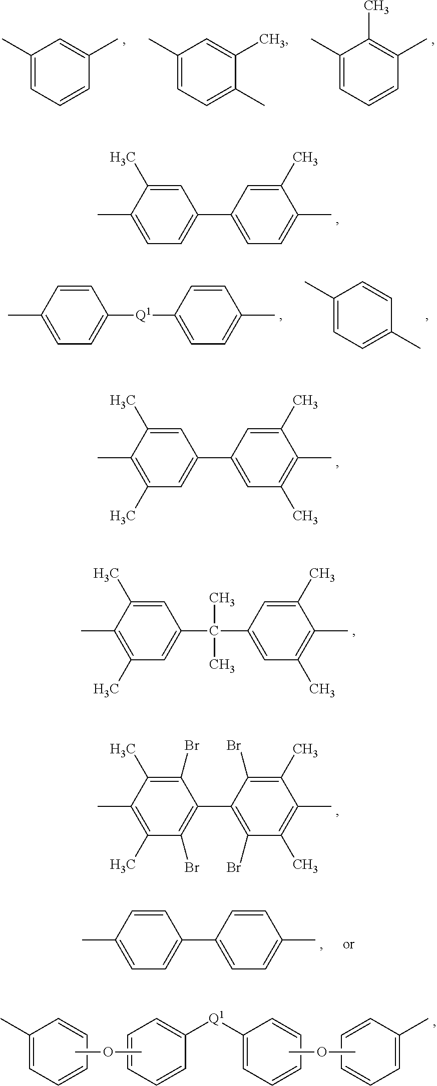

wherein Q¹ is —O—, —S—, —C(O)—, —SO₂—, —SO—, —P(R^{k})(═O)—, —C_{y}H_{2y}— or a halogenated derivative thereof, or —(C₆H₁₀)_{z}—, wherein R^{k} is a C₁₋₈ alkyl or C₆₋₁₂ aryl, y is an integer from 1 to 5, and z is an integer from 1 to 4. In a particular aspect, R² is meta-phenylene, para-phenylene, bis(4,4′-phenylene)sulfone, bis(3,4′-phenylene)sulfone, or bis(3,3′-phenylene)sulfone.

The polyimide of formula (1) can be a polyetherimide, wherein the structural units of the moiety

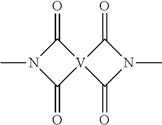

are divalent groups of formula (1b):

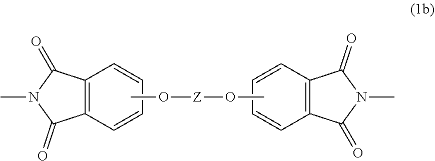

wherein the group Z in —O—Z—O— is a divalent organic group, and can be an aromatic C₆₋₂₄ monocyclic or polycyclic moiety optionally substituted with 1 to 6 heteroatoms, 1 to 8 halogen atoms, or a combination thereof, provided that the valence of Z is not exceeded. The divalent bonds of the —O—Z—O— group are in the 3,3′, 3,4′, 4,3′, or the 4,4′ positions. Exemplary groups Z include groups derived from a dihydroxy compound of formula (4):

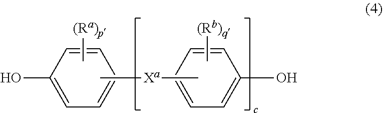

wherein R^{a} and R^{b} can be the same or different and are a halogen atom or a monovalent C₁₋₆ alkyl group, for example; p′ and q′ are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (preferably para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (4a)

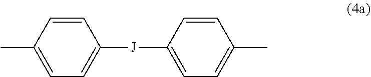

wherein J is —O—, —S—, —C(O)—, —SO₂—, —SO—, or —C_{y}H_{2y}— wherein y is an integer from 1 to 5 or a halogenated derivative thereof (including a perfluoroalkylene group). In a specific aspect, Z is a derived from bisphenol A, such that J in formula (3a) is 2,2-isopropylidene.

The polyimide can be a copolymer, for example a polyetherimide sulfone copolymer comprising structural units wherein at least 50 mol % of the repeating units in the polyimide are of formula (1), wherein Q¹ is —SO₂— and the remaining 50 mol % of repeating units in the polyimide are of formula (2). Alternatively, the polyimide can be a polyetherimide copolymer that optionally comprises additional structural imide units, for example imide units wherein V is of the formulas

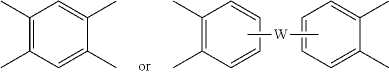

wherein W is a single bond, —O—, —S—, —C(O)—, —SO₂—, —SO—, —P(R^{j})(═O)— wherein R^{j} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units can comprise less than 20 mol %, or 0 to 10 mol %, or 0 to 5 mol %, or 0 to 2 mol % of the total number of repeating units in the polyimide, based on a total of 100 mol %. In some aspects, no additional imide units are present other than polyetherimide units when the polyimide is a polyetherimide.

For example, the polyimide can be polyetherimide including repeating units of formula (1a) and formula (2a):

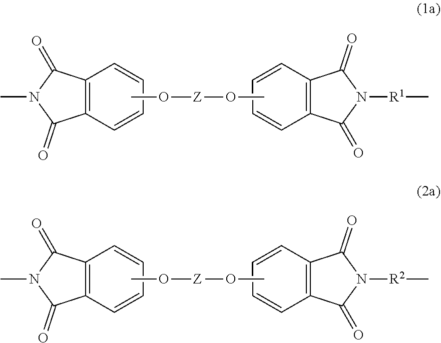

wherein each Z is independently an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded; and R¹ and R² are as described herein. In some aspects, Z is the same in formulas (1a) and (2a).

The polyimides can be prepared by methods known in the art, including a polycondensation or ether-forming polymerization.

The polyimide can be prepared by polycondensation, which includes an imidization of a dianhydride of formula (5) or formula (5a)

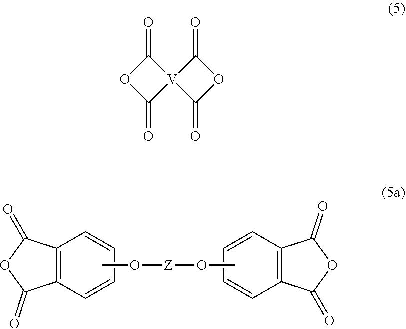

or a chemical equivalent thereof, with a diamine of formula (6), and, optionally, a diamine of formula (7):

H₂N—R¹—NH₂ (6)

H₂N—R²—NH₂ (7)

in a solvent and under conditions effective to provide the polyimide, wherein V, R¹, R² are as described herein, and wherein each V in the repeating units of formulas (5) and (5a) is the same as each V in the repeating units of formulas (1) and (2).

For example, the polyimide can be prepared by polycondensation, which includes an imidization of a dianhydride of formula (5) or formula (5a) or a chemical equivalent thereof, with a diamine of formula (6), and optionally a diamine of formula (7), in a solvent and under conditions effective to provide an anhydride-capped oligomer; and reacting the anhydride-capped oligomer with an amino compound of formula (8):

H₂N-D-A (8)

under conditions effective to provide the polyimide. In formula (8), D is substituted or unsubstituted C₁₋₂₀ alkylene, substituted or unsubstituted C₃₋₈ cycloalkylene, substituted or unsubstituted C₆₋₂₀ arylene, or substituted or unsubstituted C₃₋₁₂ heteroarylene, preferably C₁₋₂₀ alkylene or C₆₋₂₀ arylene, more preferably C₁₋₆ alkylene or C₆₋₁₂ arylene; and A is an anion, preferably carboxylate (—C(O)O⁻), sulfate (—OS(O)₂O⁻), sulfonate (—S(O)₂O⁻), phosphate (—OP(O)(OR^{d})O⁻), phosphinate (—P(O)(R^{e})O⁻), or phosphonate (—P(O)(OR^{f})O⁻ or —OP(O)(R^{g})O⁻), wherein R^{d}, R^{e}, R^{f}, and R^{g} are each independently hydrogen, substituted or unsubstituted C₁₋₈ alkyl, or substituted or unsubstituted C₆₋₁₂ aryl. In some aspects, R^{d}, R^{e}, R^{f}, and R^{g} are each independently C₁₋₃ alkyl optionally substituted with 1 to 8 halogen atoms or C₆₋₁₂ aryl optionally substituted with 1 to 6 C₁₋₈ alkyl groups, 1 to 8 halogen atoms, or a combination thereof.

Exemplary dianhydrides of formulas (5) and (5a) include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, or a combination thereof.

The diamines of formula (6) have the structure:

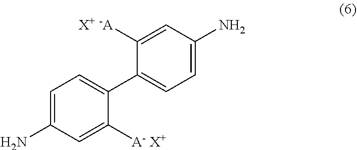

wherein A and X are as described herein. For example, the diamine of formula (6) can be a diamine represented by formula (6a):

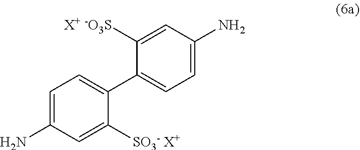

Specific examples of diamines of formula (7) include hexamethylenediamine, polymethylated 1,6-n-hexanediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis(3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), bis(4-aminophenyl) ether, or a combination thereof. Any regioisomer of the foregoing compounds can be used. For example, the diamine of formula (7) can be m-phenylenediamine, p-phenylenediamine, 4,4′-diaminodiphenyl sulfone, or a combination thereof.

A catalyst can be present during imidization. Exemplary catalysts include sodium aryl phosphinates, guanidinium salts, pyridinium salts, imidazolium salts, tetra(C₇₋₂₄ arylalkylene) ammonium salts, dialkyl heterocycloaliphatic ammonium salts, bis-alkyl quaternary ammonium salts, (C₇₋₂₄ arylalkylene)(C₁₋₁₆ alkyl) phosphonium salts, (C₆₋₂₄ aryl)(C₁₋₁₆ alkyl) phosphonium salts, phosphazenium salts, and combinations thereof. The anion can be, for example, chloride, bromide, iodide, sulfate, phosphate, acetate, mesylate, tosylate, or the like, or a combination thereof. The amount of catalyst can be, for example, 0.01 to 5 mol % percent, or 0.05 to 2 mol %, or 0.2 to 1 mol %, based on the moles of diamine (6) or (7).

The polyimides and polyetherimides can be prepared by polymerization in a solvent, for example relatively non-polar solvents with a boiling point above 100° C., or above 150° C., for example o-dichlorobenzene, dichlorotoluene, 1,2,4-trichlorobenzene, dimethylacetamide, diphenyl sulfone, anisole, veratrole, diphenylether, N-methylpyrrolidone, or phenetole. The polymerization can be at a temperature of at least 110° C., or 150 to 275° C., or 175 to 225° C. for solution polymerization. Atmospheric or super-atmospheric pressures can be used, for example up to 500 kPa, to minimize solvent loss. Reaction time varies by reactants and conditions, and can be 0.5 hours (h) to 3 days, or 0.5 to 72 h, or 1 to 30 h, or 1 to 20 h; preferably in 20 h or less, more preferably 10 h or less, even more preferably 3 h or less.

The amino endcapping compound of formula (8) can be added to the reaction mixture (i.e., the reaction mixture containing the anhydride-capped oligomer), for example 1 to 24 h, or 1 to 20 h, or 1 to 18 h after the polymerization reaction begins. After addition of the endcapping compound, the resulting mixture is subjected to continued heating, for example at 150 to 275° C., or 175 to 225° C., for an additional 1 to 10 h, or 1 to 5 h. After the step of continued heating, the reaction mixture can be subsequently heated at 200 to 450° C., or 300 to 400° C., for a period of 10 minutes (min) to 2 h, or 20 to 90 min, or 30 to 60 min.

The molar ratio of dianhydride (5) or (5a) to the combination of diamine (6) and optionally diamine (7) can be 0.9:1 to 1.1:1, or even 1:1. Advantageously, when a stoichiometric ratio is used of anhydride to amine groups and the reaction proceeds substantially to completion, this results in a polymer composition that is substantially free of unreacted anhydride and amine monomers. As used herein, “substantially free of unreacted anhydride and amine monomers” means less than 10,000 ppm, less than 5,000 ppm, less than 2,500 ppm, or less than 1,000 ppm of unreacted anhydride and amine monomers are present in the polymer or the polymer composition.

An endcapping agent can be present during imidization or added after imidization to the resulting reaction mixture. If an amine-containing endcapping agent is used, the amount can be more than 0 to 10 mol % based on the total amount of dianhydride (5) or (5a). If an anhydride-containing endcapping agent is used, the amount can be in the range of more than 0 to 20 mol %, or 1 to 10 mol % based on the amount of the diamine (6) and optionally (7). The endcapping agent can be added at any time. For example, the endcapping agents can be mixed with or dissolved into reactants having similar functionality, such as combining an anhydride-containing endcapping agent with dianhydride (5) or (5a). Where an anhydride-containing endcapping agent is used, in order to achieve maximum molecular weight, the quantity of amine functionality [2×diamine moles]=moles of anhydride functionality ([2×dianhydride moles+moles of anhydride in the endcapping agent]). In another aspect, the anhydride-capped oligomer can be reacted with an endcapping agent that is an amino compound represented by formula (8).

The polyimide can be a polyetherimide that is synthesized by an ether-forming polymerization, which proceeds via an imidization, i.e., reaction of a diamine of formula (6) and optionally (7) with an anhydride of formula (10), wherein X is a nitro group or halogen, to provide intermediate bis(phthalimide)s of formula (11) wherein R is as described as R¹ in formula (1) and optionally as R² in formula (2), and X is as described in formula (10).

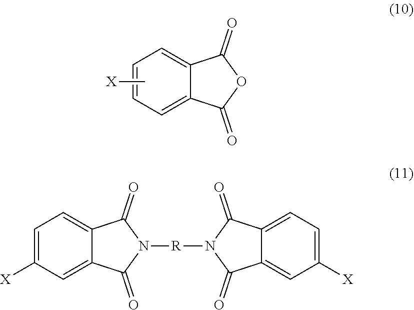

An optional catalyst or optional monofunctional chain terminating agent as described above can be present during imidization.

The bis(phthalimide) (11) is subsequently reacted with an alkali metal salt of a dihydroxy aromatic compound of formula (12)

AMO-Z-OAM (12)

wherein AM is an alkali metal and Z is as defined herein, to provide the anhydride-capped oligomer; and the anhydride-capped oligomer is optionally reacted with the amino compound (8) under conditions effective to provide the polyetherimide. Polymerization conditions effective to provide the polyetherimides are generally known and can be conducted in a solvent as described above. This polymerization can also be conducted in the melt, for example at 250 to 350° C., where a solvent is generally not present.

Also provided is a poly(amic acid) solution including 1 to 99 weight percent (wt %), or 10 to 90 wt %, or 0.1 to 20 wt % or 0.5 to 10 wt %, or 1 to 5 wt % of a poly(amic acid) derived from the dianhydride of formula (5), the diamine of formula (6), and optionally the diamine of formula (7); and a solvent. The poly(amic acid) can be prepared by combining the dianhydride (5), the diamine components of formula (6) and optionally (7), and the solvent by stirring until a viscous solution is formed. For example, a method of manufacturing the poly(amic acid) solution can include combining the components and heating with agitation or stirring at a temperature and for a time effective to dissolve the components in the solvent, or at a temperature lower than the boiling point of the solvent. The temperature is not particularly limited and can be selected to avoid instability of the poly(amic acid). Preferably, the temperature is 50° C. or less, or 30° C. or less, or 25° C. or less.

For example, a polyetherimide layer can be prepared by casting the poly(amic acid) solution onto a substrate and removing solvent from the cast layer. The solvent can be removed by any number of means, including by heating the cast layer or heating the cast layer under heat and pressure.

The polyimide can have one or more of the following properties. The polyimide can have a glass transition temperature of greater than 200° C., or 200 to 400° C., or 220 to 400° C., or 220 to 360° C., as determined by differential scanning calorimetry (DSC) or dynamic mechanical analysis (DMA); an inherent viscosity of 1.6 to 3.0 dL/g, or 1.7 to 2.9 dL/g, or 1.75 to 2.8 dL/g, as determined by flow rheology in dimethyl sulfoxide solution at a concentration of 0.5 g/dL at 30° C.; a thermal decomposition temperature of greater than 450° C., or 450 to 500° C., or 460 to 500° C., or 480 to 500° C. as determined at a 5% weight loss by thermogravimetric analysis (TGA); a water uptake of 1 to 50 wt %, or 1.5 to 40 wt %, or 2 to 40 wt %, or 5 to 40 wt %, or 10 to 40 wt %, as determined at 25° C. from the difference in the weight of the polyimide that has been immersed in water for 24 hours and the weight of the polyimide prior to immersion in water; and/or an ionic conductivity of greater than 5×10⁻⁸ Siemens per inverse centimeter (S/cm⁻¹), or greater than 7×10⁻⁸ S/cm⁻¹, or greater than 1×10⁻⁷ S/cm⁻¹, or greater than 9×10⁻⁸ S/cm⁻¹ to 1×10⁻⁶ S/cm⁻¹, or greater than 1×10⁻⁷ S/cm⁻¹ to 1×10⁻⁶ S/cm⁻¹, or greater than 2×10⁻⁷ S/cm⁻¹ to 1×10⁻⁶ S/cm⁻¹, or greater than 3×10⁻⁷ S/cm⁻¹ to 1×10⁻⁶ S/cm⁻¹, or greater than 4×10⁻⁷ S/cm⁻¹ to 1×10⁻⁶ S/cm⁻¹.

The polyimide has desirable thermal properties. For example, the polyimide can have a glass transition temperature that is greater than a glass transition temperature of comparable polyimide having a same number of repeating units of formula (1) wherein X is hydrogen. In some aspects, the polyimide can have a thermal decomposition temperature that is less than a thermal decomposition temperature of the comparable polyimide having a same number of repeating units of formula (1) wherein X is hydrogen, at a 5% weight loss by thermogravimetric analysis. Accordingly, the polyimide may be thermally stable and may have a high decomposition temperature, as shown in Table 3 below.

The polyimide has excellent water uptake properties. For example, the polyimide can have a water uptake that is greater than a water uptake of a comparable polyimide having a same number of repeating units of formula (1) wherein X is hydrogen, as determined from the difference in the weight of the polyimide before and after exposure to 95% relative humidity at 25° C. for 24 hours. The inventors have further discovered that the structures of the repeating units of the polyimide may be selected to adjust the water uptake, as shown in Table 4 below.

In another aspect, a polymer composition is provided. The polyimide can be combined with a second polymer, preferably a second polyimide, which is different from the first polyimide. Such polymer compositions can include 1 to 99 wt % of the first polyimide and 1 to 99 wt % of the second polymer, or 10 to 90% of the first polyimide and 10 to 90 wt % of the second polyimide, based on the total weight of the composition excluding solvents. For the sake of convenience, the polyimide described in conjunction with formula (1) can be referred to as the “first polyimide” to differentiate from a “second polymer” or a “second polyimide”.

Illustrative examples of second polymers include, but are not limited to, a polyacetal, poly(C₁₋₆ alkyl)acrylate, polyacrylamide, polyacrylonitrile, polyamide, polyamideimide, polyanhydride, polyarylene ether, polyarylene ether ketone, polyarylene ketone, polyarylene sulfide, polyarylene sulfone, polybenzothiazole, polybenzoxazole, polybenzimidazole, polycarbonate, polyester, poly(C₁₋₆ alkyl)methacrylate, polymethacrylamide, cyclic olefin polymer, polyolefin, polyoxadiazole, polyoxymethylene, polyphthalide, polyimide, polysilazane, polysiloxane, polystyrene, polysulfide, polysulfonamide, polysulfonate, polythioester, polytriazine, polyurea, polyurethane, vinyl polymer, or a combination thereof.

In some aspect, the second polyimide includes repeating units represented by formula (2′)

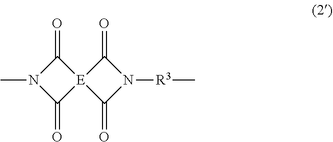

wherein each E is independently a tetravalent C₄₋₄₀ hydrocarbon group, optionally comprising 1 to 3 heteroatoms, and each R³ is independently a C₁₋₃₀ divalent hydrocarbon group, optionally comprising 1 to 4 heteroatoms. In some aspects, each E is independently a tetravalent C₄₋₄₀ hydrocarbon group, optionally comprising 1 to 2 heteroatoms, and each R³ is independently a C₁₋₃₀ divalent hydrocarbon group, optionally comprising 1 to 2 heteroatoms. In some aspects, each E is independently a tetravalent C₄₋₄₀ hydrocarbon group, optionally comprising 1 heteroatom, and each R³ is independently a C₁₋₃₀ divalent hydrocarbon group, optionally comprising 1 heteroatom. In some aspects, E is independently a tetravalent C₄₋₄₀ hydrocarbon group and each R³ is independently a C₁₋₃₀ divalent hydrocarbon group, wherein optional heteroatoms are not present.

The polymer composition can include various additives ordinarily incorporated into compositions of these types, with the proviso that any additive is selected to not significantly adversely affect the desired properties of the composition. Exemplary additives include antioxidants, thermal stabilizers, light stabilizers, ultraviolet light (UV) absorbing additives, quenchers, plasticizers, lubricants, mold release agents, antistatic agents, visual effect additives such as dyes, pigments, and light effect additives, flame resistances, anti-drip agents, and radiation stabilizers. Particulate fillers and reinforcing fillers can also be present, and include mineral fillers, flaked fillers, carbon nanotubes, exfoliated nanoclays, carbon nanowires, carbon nanospheres, carbon-metal nanospheres, carbon nanorods, carbon-metal nanorods, nanoparticles, insoluble polymers, glass fibers, carbon fibers, glass-carbon fibers, talc including fibrous, modular, needle shaped, and lamellar talc, graphite, fibrillated fluoropolymers, polymer fibers and filaments, woven fibers, metal particles, inorganic fibers, single crystal fibers or “whiskers”, or the like. Combinations of additives can be used. The foregoing additives can be present individually in an amount from 0.005 to 10 wt %, or combined in an amount from 0.005 to 20 wt %, preferably 0.01 to 10 wt %, based on the total weight of the composition.

Also provided herein is an article that includes the polyimide, polyimide composition, or polymer composition. A wide variety of articles can be manufactured, for example articles of utility in automotive, telecommunication, aerospace, electrical/electronics, battery manufacturing, wire coatings, transportation, food industry, and healthcare applications. Such articles can include films, membranes, fibers, foams, sheets, conductive parts, coatings, preforms, composites, varnishes, lenses, or the like. For example, the article may be an open or closed cell foam, a nano-foam, a battery separator, an ion exchange membrane, tubing, a capillary, an anti-static coating, a self-cleaning surface, an anti-fouling surface, or a scratch resistant part. Another particular example is a separator for a secondary battery, such as a lithium ion battery. The articles can be extruded or molded, for example injection molding, melt extrusion, thermoforming, or roto-molding. The articles can be made by an additive manufacturing method, for example three-dimensional printing. Components for electronic devices and components for sterilizable medical articles are especially useful. Thin-wall components manufactured by injection molding are useful, such as a wall having a thickness from 0.1 to 10 millimeters (mm), or 0.2 to 5 mm, or 0.5 to 2 mm. For example, a film can be manufactured by solution-casting or melt processing the polyimide, the polyimide compositions, the polyetherimide compositions, and the polymer compositions described herein.

Membranes can be formed from the sulfonated polyimides by methods known to those skilled in the art. These membranes can find application as proton exchange membranes in fuel cells or as ion exchange membranes in ion exchange applications. An exemplary method for forming a membrane includes dissolving the sulfonated polyimide or polymer composition in a suitable solvent such as DMAC and followed by casting directly onto a glass substrate.

The polyimides and compositions are further illustrated by the following non-limiting examples.

### EXAMPLES

Table 1 list components that are used in the examples.

TABLE 1

| Component | Description |
|---|---|
| LiOH | Lithium hydroxide (Aldrich) |
| NaOH | Sodium hydroxide (Aldrich) |
| BDSA | 2,2′-Benzidinedisulfonic acid |
| | (TCI America) |
| mPD | m-phenylene diamine (TCI America) |
| BPADA | 2,2-bis[4-(3,4-dicarboxyphenoxy)phenyl]propane |
| | dianhydride (4,4′-Bisphenol A dianhydride) |
| | (TCI America) |
| PEI | Polyetherimide from reaction of bisphenol A |
| | dianhydride and meta-phenylene diamine, phthalic |
| | anhydride end-capped, with an MFR of about 9 g/10 min |
| | at 337° C. and 6.6 kg, obtained as ULTEM 1000 |
| | (SHPP) |
| EMIM—TF2N | 1-Ethyl-3-methyl-1-H-imidazolium |
| | bis(trifluoromethansulfonyl)imide (Aldrich) |

Physical testing of the compositions was conducted according to the following test methods and procedures. Unless indicated otherwise, all test standards set forth herein are the test standards in effect as of 2016.

Thermogravimetric analysis (TGA) was performed from 25 to 600° C. with a 10° C./min heating rate and N₂ fill gas using a TA instruments Q50. Differential scanning calorimetry (DSC) was conducted using a TA Instruments Q2000 DSC coupled with a RCS90 refrigerated cooling system and 50 mL/min N₂ cell purge. A heat/cool/heat procedure was utilized with 25° C./min heating and cooling. Glass transition (T_{g}) values were determined according to ASTM D3418 from the second heat cycle via inflection point using TA Universal Analysis software.

Dynamic mechanical analysis (DMA) revealed modulus versus temperature behavior utilizing a TA Instruments Q800 Dynamic Mechanical Analyzer in oscillatory tension mode at a 1 Hz frequency, a 15 micrometer (m) oscillatory amplitude, and a 0.01 normal (N) static force with a 3° C./min heating ramp.

Proton nuclear magnetic resonance (¹H NMR) spectroscopy was performed at 25° C. using a Varian Unity 400 at 400 MHz D₂O served as the solvent for NMR analysis.

Inherent viscosity measurements were done using a viscometer heated to 30° C.

X-ray scattering was performed using a Rigaku S-Max 3000 with exposure times of 2 h and a 0.154 nm (Cu Kα) light source with a sample-to-detector distance of 1005 mm. Films were dried before analysis via X-ray scattering.

Water uptake measurements were done over 24 hours using a TGA-Q5000-Sorption Analyzer operating at 25° C. and 95% relative humidity. The uptake was taken from the plateau in weight gain for 2 mg film samples dried at 200° C. before testing.

Conductivity measurements were conducted using a Metrohm Autolab B.V. impedance analyzer operating between 100000-0.1 hertz (Hz) with 0.2 volts (V) amplitude at, 20% relative humidity and 23° C. Ionic conductivity was calculated according to Equation 1:

$$σ = L / AR \qquad Equation 1$$

wherein L is film thickness, A is film area, and R is the plateau of impedance from the Bode plot.

### Example 1: Purification of BDSA

The structure of BDSA is shown in Formula (13), where X is Li or Na.

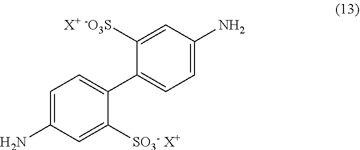

The synthesis of BDSA-Na is as follows. 10 grams (g) of BDSA powder was charged to a 250 milliliters (mL) flask containing 50 mL of deionized (DI) water and 1.675 g of NaOH or 0.92 g of LiOH. The flask was heated until a clear solution was obtained. The homogenous solution was then precipitated into 60 mL of cold ethanol. The mixture was filtered and the resulting solid was dried before being dissolved in 25 mL of hot DI water. Following complete dissolution of the BDSA-Na, an excess of an aqueous solution of 37% HCl was added to the solution. The resulting solid was then vacuum filtered. This procedure was repeated three times, providing a white powder which was again titrated with the base of choice, NaOH or LiOH, and precipitated into cold ethanol and filtered. The obtained powder was stored in a vacuum oven at 150° C. to combat the uptake of water. ¹H NMR confirmed the structure of the purified monomer.

### Example 2: Synthesis of Poly(Amic Acid) Solution

Scheme 1 shows the general reaction pathway for poly(amic acid) formation and thermal imidization to form a metal sulfonated polyetherimide copolymer. The reaction solution of the poly(amic acid) is subsequently cast on a glass substrate to form a film and thermally imidized using a vacuum chamber in a heated metal bath. In the exemplary reaction scheme below, x and y represent the mole percent (mol %) of repeating units and M is Na or Li.

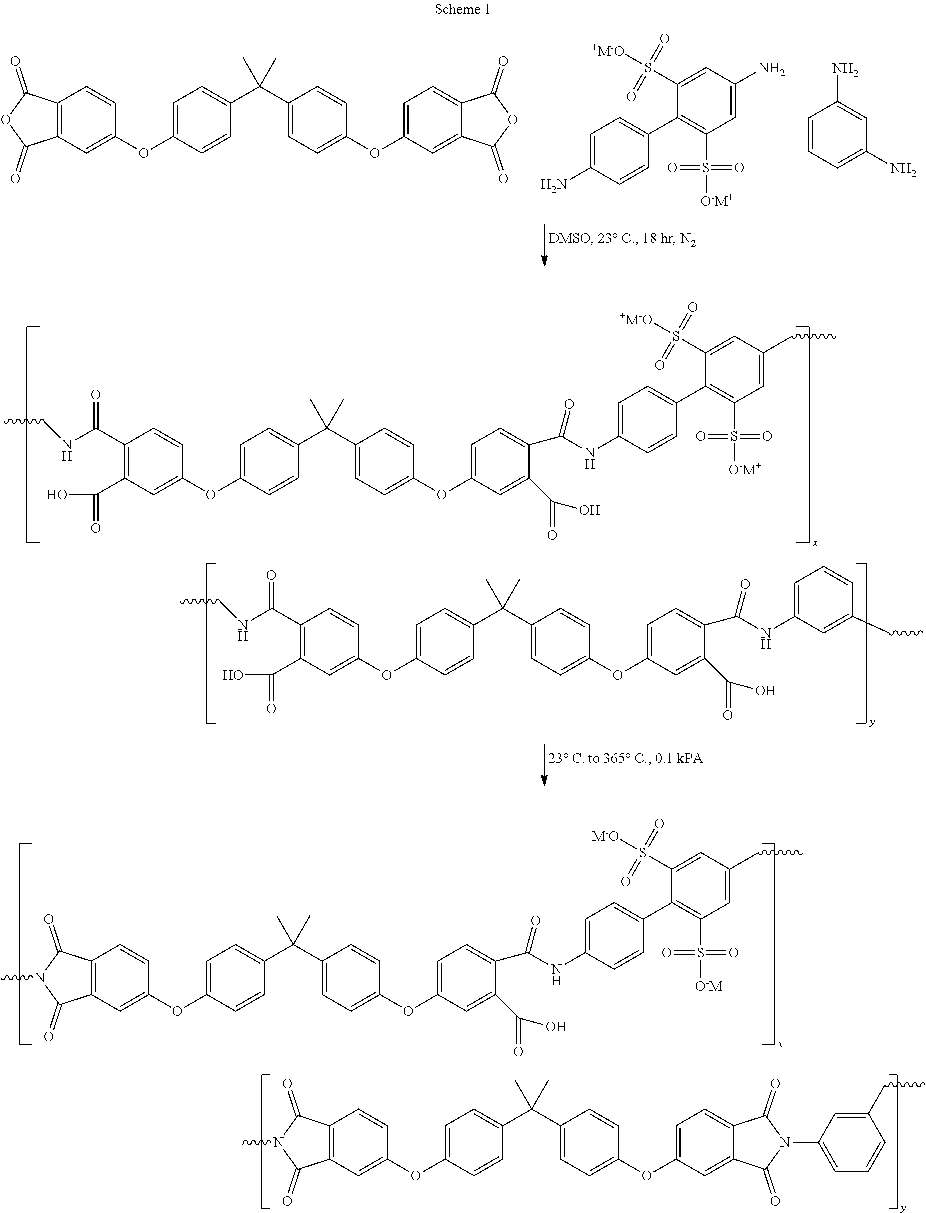

A representative series of poly(amic acid) solutions were prepared as follows. To a two neck round bottom flask equipped with a magnetic stir bar and nitrogen inlet was added mPD (0.3947 g, 0.00365 mols (mol)) and BDSA-Li (0.068 g, 0.0001921 mol, ca. 5 mol %). The flask was purged and backfilled with N₂ three times before addition of 15 mL of anhydrous DMSO. Following complete dissolution of the amines, BPADA (2.000 g, 0.003842 mol) was added to the solution with an additional 5 mL of DMSO. The resultant viscous yellow solution wherein the polymer has a stoichiometric ratio of amine groups to anhydride groups (e.g., 1:1) was allowed to stir under nitrogen for 12 hours before being stored in a refrigerator at 8° C. A similar procedure was used to prepare separate poly(amic acid) solutions using 25, 50 and 75 mol % of BDSA-Li and 5, 25, 50, and 75 mol % of BDSA-Na. Poly(amic acid) solutions were also separately prepared by this method without using mPD, i.e., using 100 mol % BDSA-Li or 100 mol % of BDSA-Na, respectively.

As used herein, “5 mol % BDSA-M,” “25 mol % BDSA-M,” “50 mol % BDSA-M,” “75 mol % BDSA-M,” and “50 mol % BDSA-M”, wherein M is Na or Li, refers to the ionic mol % that was determined based on the original amount of BDSA-M during polymerization relative to the molar amount of BPADA. Thus, on a repeat unit basis, 5 mol % BDSA-M indicates that 1 of every 20 repeating units bears the metalated disulfonated monomer and the remaining 19 units were comprised of mPD. For example, a label of 5 mol % BDSA-Na would comprise 1 molar equivalent of BPADA, 0.95 molar equivalents of mPD and 0.05 molar equivalents of BDSA-Na.

### Example 3: Polyimide Film Formation

Each of the poly(amic acid) solutions from Example 2 was allowed to warm to room temperature and was bladed on a glass slide on a level surface without additional DMSO. The slide was then placed into a vacuum oven and kept at room temperature for 1 h before being slowly ramped to 200° C. The film was then held at 200° C. for 0.5 h and then transferred to a vacuum chamber residing in a Bi/Sn metal bath. The chamber was then heated slowly to 350° C. and held at that temperature for 0.5 h to facilitate cyclodehydration of the poly(amic acid) to the desired metal sulfonated polyetherimides. Films were then cooled slowly to room temperature and delaminated using DI water and dried at 60° C. overnight before analysis.

The obtained amber, thin films displayed outstanding mechanical integrity, outside of 100 mol % BDSA-Li, which did not provide a creasable film. While the poly(amic acid)s displayed solubility in DMSO and NMP, the solubility of the metal sulfonated polyetherimides was perturbed using BDSA-Na and BDSA-Li in these samples. When evaluated in other solvents used for polyether imides, such as 1,2-dichlorobenzene and/or chloroform, were unable to dissolve any of the metal sulfonated polyetherimide film samples. Furthermore, the imidized samples were insoluble in DI water.

### Rheological Properties

The inherent viscosity (η_{Inh}) of the polyetherimide films prepared from the poly(amic acid) solutions including 5 mol %, 25 mol %, 50 mol %, 75 mol %, and 100 mol % of the BDSA-Na are shown in Table 2 and reported in deciliters per gram (dL/g). The imidized films were not crosslinked, as inherent viscosity measurements are not possible on crosslinked polymeric materials.

TABLE 2

| Sample | η_{Inh} (dL/g) |
|---|---|
| PEI | 1.55 |
| 5 mol % BDSA—Na | 1.79 |
| 25 mol % BDSA—Na | 1.97 |
| 50 mol % BDSA—Na | 2.07 |
| 75 mol % BDSA—Na | 2.15 |
| 100 mol % BDSA—Na | 2.75 |
| 5 mol % BDSA—Li | 1.85 |
| 25 mol % BDSA—Li | 1.93 |
| 50 mol % BDSA—Li | 2.34 |
| 75 mol % BDSA—Li | 2.82 |
| 100 mol % BDSA—Li | 3.16 |

The results in Table 2 show that inherent viscosities of greater than 1.55 dL/g were achieved for all of the BDSA-Na and BDSA-Li samples, which is consistent with the formation of products having moderate to high molecular weights during the polymerization.

### Thermal Properties

Table 3 shows the thermal properties and char yields for the indicated polyetherimide films.

TABLE 3

| | T_{d, 5%} | DSC T_{g} | DMA T_{g} | Char Yield |
|---|---|---|---|---|
| Sample | (° C.) | (° C.) | (° C.) | (wt %) |
| PEI | 521 ± 1 | 216 | 217 | 63 ± 0.8 |
| 5 mol % BDSA—Na | 498 ± 3 | 228 | 230 | 57 ± 0.5 |
| 25 mol % BDSA—Na | 487 ± 2 | * | 252 | 58 ± 1.3 |
| 50 mol % BDSA—Na | 480 ± 5 | * | 357 | 63 ± 1.4 |
| 75 mol % BDSA—Na | 484 ± 2 | * | * | 64 ± 0.6 |
| 100 mol % BDSA—Na | 489 ± 4 | * | * | 67 ± 1.1 |
| 5 mol % BDSA—Li | 500 ± 2 | 232 | 236 | 58 ± 1.6 |
| 25 mol % BDSA—Li | 480 ± 4 | 260 | 263 | 63 ± 0.9 |
| 50 mol % BDSA—Li | 486 ± 7 | * | 381 | 63 ± 2.0 |
| 75 mol % BDSA—Li | 480 ± 5 | * | * | 69 ± 0.7 |
| 100 mol % BDSA—Li | 478 ± 3 | * | * | 73 ± 1.2 |

* value could not be measured

As shown in Table 3, thermogravimetric analysis of the metal sulfonated PEIs by DSC and/or DMA revealed increased T_{g} temperatures for both the BDSA-Li and BDSA-Na series that correlated to increased ionic mole percent. Without wishing to be bound to theory, the results of the TGA weight loss experiments on the thermally treated PEI films revealed no weight loss before degradation of the backbone, corresponding to complete imidization of the metal sulfonated PEIs.

Table 3 further shows the char yields of the film samples. As shown in Table 3, char yield improved at greater than 25 mol % of BDS-M incorporation for both sodium and lithium samples. As seen in the monomer char-yields, lithium sulfonated PEIs yielded higher char yields in all cases relative to the sodium analogs.

### Water Uptake Measurements

Table 4 shows the water uptake results.

TABLE 4

| | Water Uptake |
|---|---|
| Sample | (wt %) |
| PEI | 0.8 |
| 5 mol % BDSA—Na | 1.7 |
| 25 mol % BDSA—Na | 3.5 |
| 50 mol % BDSA—Na | 8.9 |
| 75 mol % BDSA—Na | 16.3 |
| 100 mol % BDSA—Na | 20.8 |
| 5 mol % BDSA—Li | 1.8 |
| 25 mol % BDSA—Li | 4.6 |
| 50 mol % BDSA—Li | 14.1 |
| 75 mol % BDSA—Li | 17.1 |
| 100 mol % BDSA—Li | 33.2 |

Along with increased T_{g}, the incorporation of BDSA-Na and BDSA-Li modulated hydrophilicity. Water-uptake measurements at controlled humidity (95% relative humidity) and temperature (25° C.) for dried, imidized samples was used to determine the role of BDSA-M incorporation on the ability of PEI to gain water by exposure to a humid atmosphere. Installation of BDSA-Na or BDSA-Li resulted in large increases in water uptake, with 100 mol % BDSA-Na displaying ˜22 wt % increase. Additionally, increasing loading of BDSA-Na or BDSA-Li resulted in increased water uptake for samples relative to PEI, representing tunable hydrophilicity through variation of BDSA-M loading. As seen with T_{g}, BDSA-Li achieved greater water uptake relative to BDSA-Na. When plotted against the concentration of SO₃⁻⁺M, the number of water molecules per sulfonate displayed an increasing trend, with higher BDSA-Na and BDSA-Li sulfonates receiving higher degrees of hydration (i.e., higher water uptake) relative to lower mol % loadings, and lithium samples higher than sodium samples.

### X-Ray Scattering

Scattering experiments probed the morphology of the BDSA-Na and BDSA-Li samples. Small-angle X-ray scattering (SAXS) of dried, imidized films indicated production of correlation peaks at lower q values, i.e., larger domain spacing, with lower sulfonation. For lower BDSA-Na and BDSA-Li loadings, the peak is frequently broader than Nafion and shifted to higher q values indicating a wider distribution of structural correlations and due to pronounced hydrophobic/hydrophilic separation caused by lower acidity relative to Nafion. At higher degrees of metal sulfonation (i.e., >25 mol %), the correlation peak begins to sharpen and shift to higher q. BDSA-Na bearing polymers produced larger domain spacing relative to the BDSA-Li series until >50 mol % incorporation. 100 mol % BDSA-Na and 100 mol % BDSA-Li achieved a reduced domain spacing to about 2 nm, whereas 5 mol % BDSA-Na and BDSA-Li exhibited domain spacings of about 6.3 nm and about 4.5 nm, respectively

### Impedance Testing

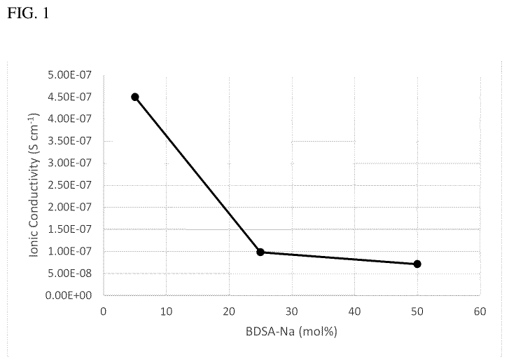

Passive swelling of the sulfonated PEIs with an ionic liquid were evaluated for ionic conductivity based on impedance measurements. FIG. 1 and Table 5 show the ionic conductivity (Siemens per inverse centimeter, S cm¹) for select examples as obtained from Nyquist plots.

TABLE 5

| | Ionic Conductivity |
|---|---|
| Sample | (S cm⁻¹) |
| 5 mol % BDSA—Na | 4.5 × 10⁻⁷ |
| 25 mol % BDSA—Na | 9.8 × 10⁻⁸ |
| 50 mol % BDSA—Na | 7.1 × 10⁻⁸ |

Impedance testing was used to examine the influence of microstructure on performance. Attempts at testing hydrated and dried BDSA-Na samples produced Bode plots with no desirable plateau and Nyquist plots without characteristic semi-circle profiles. Passive swelling of sulfonated PEIs with ionic liquid, 1-ethyl-3-methyl-1-H-imidazolium bis(trifluoromethansulfonyl)imide (EMI-TF2N), followed by impedance testing allowed probing of ionic conductivity. Following a submersion in EMI-TF2N, the 5 mol %, 25 mol %, and 50 mol % BDSA-Na films displayed remarkably similar weight gains of about 12%. Without wishing to be bound to theory, swelling of the films with conductive ionic liquid augmented the ionic transport of the PEIs.

As shown in Table 5, the film derived from 5 mol % BDSA-Na yielded the highest conductivity of 4.5×10⁻⁷ S·cm⁻¹. This was unexpected because greater degrees or amounts of sulfonation are known to improve conductivity. Without wishing to be bound to theory, when coupled with the EMI-TF2N uptake, the higher conductivity at lower sulfonation can be attributed to enhanced solvation of the sulfonate moieties.

This disclosure is further illustrated by the following non-limiting aspects.

Aspect 1. A polyimide, including 1 to 100 mol %, or 1 to 99 mol %, or 1 to 50 mol %, or 1 to 25 mol %, or 1 to 15 mol % of repeating units of formula (1), based on 100 mol % of total repeating units of the polyimide:

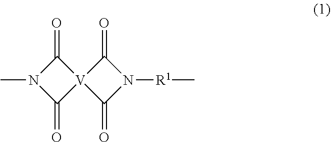

wherein each V is independently a group of formulae:

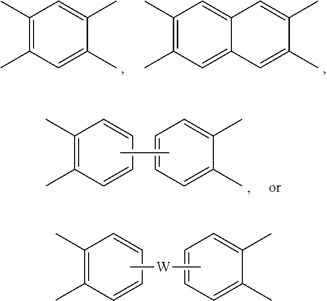

wherein W is —O—, —S—, —C(O)—, —SO₂—, —SO—, —P(R^{c})(═O)— wherein R^{c} is a C₁₋₈ alkyl or C₆₋₁₂ aryl, —C_{y}H_{2y}— wherein y is an integer from 1 to 5 or a halogenated derivative thereof, or a group of the formula —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded; and each R¹ is independently a divalent group of formula (3):

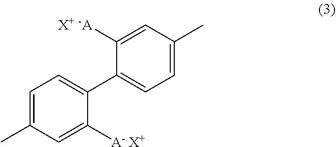

wherein A is anionic, and each A is independently —O, —S, —S(O)₂, —S(O)₂O, —OS(O)₂O, —OP(O)(OR^{d})O, —P(O)(R^{e})O, —P(O)(OR^{f})O, or —OP(O)(R^{g})O; X is cationic, and each X is independently Li, Na, K, Cs, Mg, Ca, Sr, Cr, Mn, Fe, Co, Ni, Cu, Ag, Zn, Cd, B, Al, Ga, In, Ge, Sn, Pb, As, Sb, phosphonium, imidazolium, guanidinium, or pyridinium, and R^{d}, R^{e}, R^{f}, and R^{g} are each independently hydrogen, substituted or unsubstituted C₁₋₈ alkyl, or substituted or unsubstituted C₆₋₁₂ aryl, optionally, wherein the polyimide includes at least one endcap derived from an endcapping agent.

Aspect 2. The polyimide of aspect 1, wherein the polyimide further comprises 1 to 99 mol %, or 1 to 95 mol %, or 10 to 90 mol %, or 25 to 85 mol %, or 50 to 75 mol % of repeating units of formula (2), based on 100 mol % of total repeating units of the polyimide:

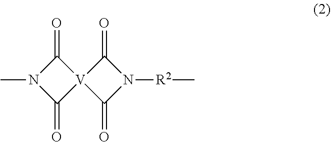

wherein each V is independently a tetravalent C₄₋₄₀ hydrocarbon group, optionally comprising 1 to 3 heteroatoms; each R² is independently a C₁₋₃₀ divalent hydrocarbon group, optionally comprising 1 to 4 heteroatoms; and wherein each V in the repeating units of formula (1) is the same as or different than each V in the repeating units of formula (2).

Aspect 2a. The polyimide of aspect 2, wherein each V optionally comprises 1 to 2 heteroatoms.

Aspect 2b. The polyimide of aspect 1, the polyimide further comprises 1 to 99 mol %, or 1 to 95 mol %, or 10 to 90 mol %, or 25 to 85 mol %, or 50 to 75 mol % of repeating units of formula (2), based on 100 mol % of total repeating units of the polyimide:

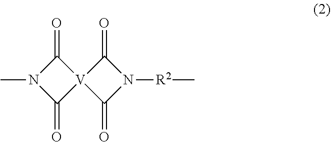

wherein each V is independently a tetravalent C₄₋₄₀ hydrocarbon group, optionally comprising 1 to 3 heteroatoms; each R² is independently a C₁₋₃₀ divalent hydrocarbon group; and wherein each V in the repeating units of formula (1) is the same as or different than each V in the repeating units of formula (2).

Aspect 3. The polyimide of aspect 2, wherein each V is independently a group of formulae:

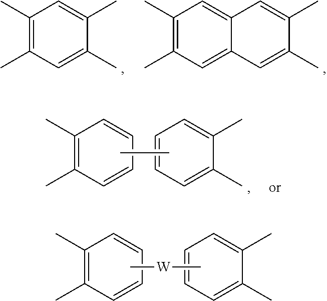

wherein W is —O—, —S—, —C(O)—, —SO₂—, —SO—, —P(R^{c})(═O)— wherein R^{c} is a C₁₋₈ alkyl or C₆₋₁₂ aryl, —C_{y}H_{2y}— wherein y is an integer from 1 to 5 or a halogenated derivative thereof, or a group of the formula —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded.

Aspect 4. The polyimide of any one of the preceding aspects, wherein the polyimide is a polyetherimide comprising repeating units of formulae (1a) and (2a):

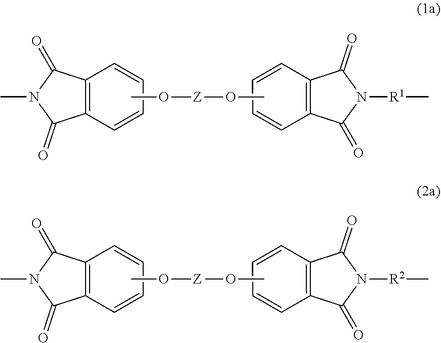

wherein each Z is independently an aromatic C₆₋₂₄ monocyclic or polycyclic moiety optionally substituted with 1 to 6 heteroatoms, 1 to 8 halogen atoms, or a combination thereof, provided that the valence of Z is not exceeded; and R¹ and R² are as defined in claim 1 or 2; preferably wherein each Z is the same.

Aspect 4a. The polyimide of aspect 4, optionally comprising repeating units of formula (1), based on 100 mol % of total repeating units of the polyimide:

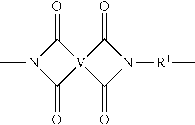

wherein each V is independently a group of formulae:

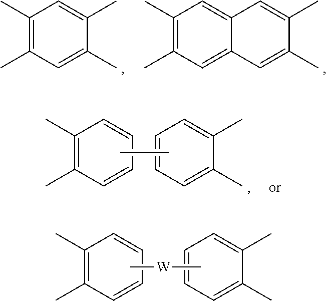

wherein W is —O—, —S—, —C(O)—, —SO₂—, —SO—, —P(R^{c})(═O)— wherein R^{c} is a C₁₋₈ alkyl or C₆₋₁₂ aryl, —C_{y}H_{2y}— wherein y is an integer from 1 to 5 or a halogenated derivative thereof.

Aspect 5. The polyimide of aspect 3 or 4, wherein each Z is independently derived from a dihydroxy compound of formula (4):

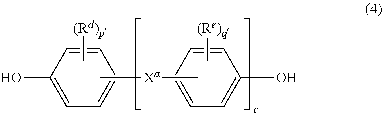

wherein each R^{d} and R^{e} is independently a halogen atom or a monovalent C₁₋₆ alkyl group, p′ and q′ are each independently integers of 0 to 4; c is 0 to 4; and X^{a} is a divalent bridging group; preferably wherein each Z is independently a divalent group of formula (4a)

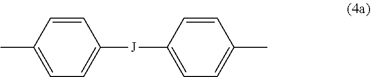

wherein J is —O—, —S—, —C(O)—, —SO₂—, —SO—, or —C_{y}H_{2y}— wherein y is an integer from 1 to 5 or a halogenated derivative thereof, preferably isopropylidene.

Aspect 6. The polyimide of any one of the preceding aspects, wherein each R² is independently a C₆₋₃₀ aromatic hydrocarbon group or a halogenated derivative thereof, a straight or branched chain C₂₋₂₀ alkylene group or a halogenated derivative thereof, or a C₃₋₈ cycloalkylene group or halogenated derivative thereof; preferably wherein each R² is independently a divalent group of formulae:

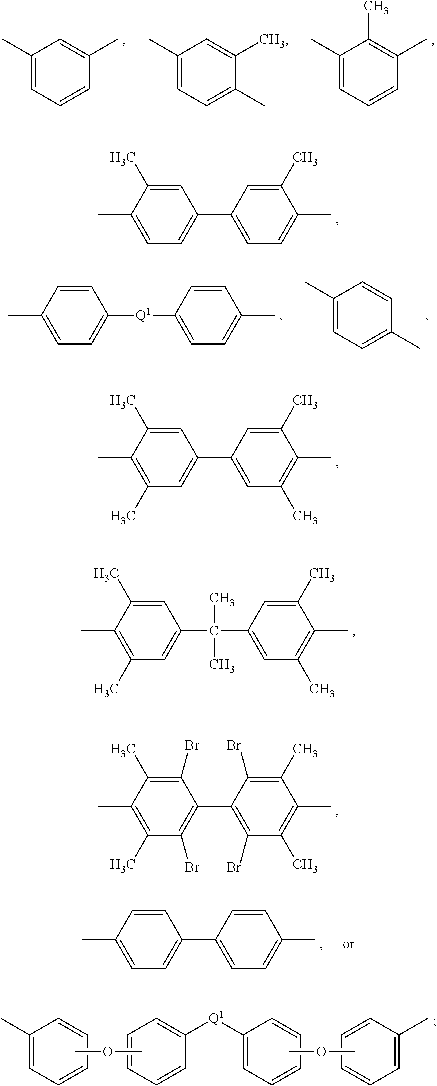

wherein, Q¹ is —O—, —S—, —C(O)—, —SO₂—, —SO—, —P(R^{k})(═O)—, —C_{y}H_{2y}— or a halogenated derivative thereof, or —(C₆H₁₀)_{z}—, R^{k} is a C₁₋₈ alkyl or C₆₋₁₂ aryl, y is an integer from 1 to 5, and z is an integer from 1 to 4; more preferably wherein each R² is independently meta-phenylene, para-phenylene, bis(4,4′-phenylene)sulfone, bis(3,4′-phenylene)sulfone, or bis(3,3′-phenylene)sulfone.

Aspect 7. The polyimide of any one of the preceding aspects, wherein each R¹ is independently a group represented by formula (3a):

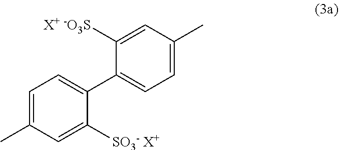

wherein each X is Li, Na, K, Cs, Mg, Ca, Sr, Zn, phosphonium, imidazolium, guanidinium, pyridinium, or a combination thereof; or wherein X is Li, Na, K, Cs, or a combination thereof.

Aspect 8. The polyimide of any one of the preceding aspects, wherein the polyimide has one or more of: an inherent viscosity of 1.6 to 3.0 dL/g, or 1.7 to 2.9 dL/g, or 1.75 to 2.8 dL/g, as determined by flow rheology in dimethyl sulfoxide solution at a concentration of 0.5 g/dL at 30° C.; or a glass transition temperature of greater than 200° C., or 200 to 400° C., or 220 to 400° C., or 220 to 360° C., as determined by differential scanning calorimetry; or a thermal decomposition temperature of greater than 450° C., or 450 to 500° C., or 460 to 500° C., as determined at a 5% weight loss by thermogravimetric analysis; or a water uptake of 1 to 50 wt %, or 1.5 to 40 wt %, or 2 to 40 wt %, or 5 to 40 wt %, or 10 to 40 wt %, as determined from the difference in the weight of the polyimide before and after exposure to 95% relative humidity at 25° C. for 24 hours; and/or an ionic conductivity of greater than 5×10⁻⁸ Siemens per inverse centimeter (S/cm⁻¹), or greater than 7×10⁻⁸ S/cm⁻¹, or greater than 1×10⁻⁷ S/cm⁻¹, or greater than 9×10⁻⁸ S/cm⁻¹ to 1×10⁻⁶ S/cm⁻¹, or greater than 1×10⁻⁷ S/cm⁻¹ to 1×10⁻⁶ S/cm⁻¹, or greater than 2×10⁻⁷ S/cm⁻¹ to 1×10⁻⁶ S/cm⁻¹, or greater than 3×10⁻⁷ S/cm⁻¹ to 1×10⁻⁶ S/cm⁻¹, or greater than 4×10⁻⁷ S/cm⁻¹ to 1×10⁻⁶ S/cm⁻¹.

Aspect 9. The polyimide of any one of the preceding aspects, wherein the polyimide has a glass transition temperature that is greater than a glass transition temperature of comparable polyimide having a same number of repeating units of formula (1) wherein X is hydrogen; the polyimide has a water uptake that is greater than a water uptake of a comparable polyimide having a same number of repeating units of formula (1) wherein X is hydrogen, as determined from the difference in the weight of the polyimide before and after exposure to 95% relative humidity at 25° C. for 24 hours; or a combination thereof.

Aspect 10. A method for the manufacture of the polyimide of any one of the preceding aspects, wherein the polyimide is a polyimide copolymer, the method comprising reacting a dianhydride of formula (5):

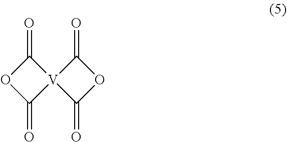

or a chemical equivalent thereof, with a diamine of formula (6), and, optionally, a diamine of formula (7):

H₂N—R¹—NH₂ (6)

H₂N—R²—NH₂ (7)

in a solvent and under conditions effective to provide the polyimide, wherein V, R¹, and R² are as defined herein, and wherein each V in the repeating units of formula (5) is the same as each V in the repeating units of formula (1).

Aspect 11. A method for the manufacture of the polyimide of any one of aspects 3 to 9, wherein the polyimide is a polyetherimide, the method comprising reacting a dianhydride of formula (5a):

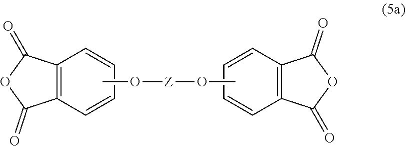

with a diamine of formula (6), and, optionally, a diamine of formula (7):

H₂N—R¹—NH₂ (6)

H₂N—R²—NH₂ (7)

in a solvent and under conditions effective to provide the polyetherimide, wherein R¹ and R² are as defined herein, and wherein each Z in the repeating units of formula (5a) is the same as each Z in the repeating units of formula (2a).

Aspect 12. The method of aspect 10 or 11, further comprising: reacting the dianhydride of formula (5) or (5a) with the diamine of formula (6) and optionally the diamine of formula (7) in a solvent and under conditions effective to provide an anhydride-capped oligomer; and reacting an anhydride-capped oligomer with an amino compound of formula (8) under conditions effective to provide the polyimide of any one of aspects 1-9,

H₂N-D-A (8)

wherein, D is substituted or unsubstituted C₁₋₂₀ alkylene, substituted or unsubstituted C₃₋₈ cycloalkylene, substituted or unsubstituted C₆₋₂₀ arylene, or substituted or unsubstituted C₃₋₁₂ heteroarylene, preferably C₁₋₂₀ alkylene or C₆₋₂₀ arylene, more preferably C₁₋₆ alkylene or C₆₋₁₂ arylene; and A is an anion, preferably carboxylate, sulfate, sulfonate, phosphate, phosphinate, or phosphonate.

Aspect 13. A poly(amic acid) solution, comprising: 1 to 99 weight percent, or 10 to 90 weight percent, or 0.1 to 20 weight percent, or 0.5 to 10 weight percent, or 1 to 5 weight percent of a poly(amic acid) derived from the dianhydride of formula (5), the diamine of formula (6), and optionally the diamine of formula (7); and a solvent, wherein the dianhydride of formula (5), the diamine of formula (6), and the diamine of formula (7) are as defined in any one of the preceding aspects.

Aspect 14. A polymer composition, comprising: the polyimide of any one of the preceding claims; and a second polyimide different from the polyimide, wherein the second polyimide comprises repeating units represented by formula (2′):

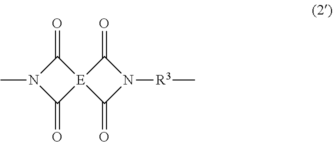

wherein each E is independently a tetravalent C₄₋₄₀ hydrocarbon group, optionally comprising 1 to 3 heteroatoms, and each R³ is independently a C₁₋₃₀ divalent hydrocarbon group, optionally comprising 1 to 4 heteroatoms.

Aspect 14a. The polymer composition of aspect 14, wherein E is independently a tetravalent C₄₋₄₀ hydrocarbon group, optionally comprising 1 to 3 heteroatoms, and each R³ is independently a C₁₋₃₀ divalent hydrocarbon group, optionally comprising 1 to 2 heteroatoms.

Aspect 14b. A polymer composition, comprising: the polyimide of any one of the preceding claims; and a second polyimide different from the polyimide, wherein the second polyimide comprises repeating units represented by formula (2′):

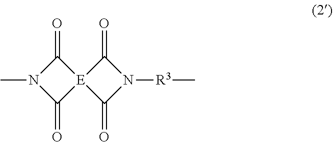

wherein each E is independently a tetravalent C₄₋₄₀ hydrocarbon group, optionally comprising 1 to 3 heteroatoms, and each R³ is independently a C₁₋₃₀ divalent hydrocarbon group.

Aspect 15. An article comprising the polyimide of any one of the preceding claims, preferably wherein the article is a film, a membrane, a fiber, a foam, a sheet, a conductive part, a coating, a preform, a composite, a varnish, or a lens; more preferably wherein the article is an open cell foam, a closed cell foam, a nano-foam, a battery separator, an ion exchange membrane, tubing, a capillary, or a scratch resistant part; even more preferably wherein the article is a separator for a secondary battery.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

The singular forms “a,” “an,” and “the” include plural referents unless the context clearly dictates otherwise. “Or” means “and/or” unless clearly indicated otherwise by context. The endpoints of all ranges directed to the same component or property are inclusive and independently combinable. Disclosure of a narrower range or more specific group in addition to a broader range is not a disclaimer of the broader range or larger group. “Combination thereof” as used herein is open-ended and means that a combination comprises one or more of the listed items, optionally with one or more like items not listed.

Unless defined otherwise, technical and scientific terms used herein have the same meaning as is commonly understood by one of skill in the art to which this disclosure belongs. A “combination” is inclusive of blends, mixtures, alloys, reaction products, and the like. “Hydrocarbyl” and “hydrocarbon” refer broadly to a group comprising carbon and hydrogen, optionally with 1 to 3 heteroatoms, for example, oxygen, nitrogen, halogen, silicon, sulfur, or a combination thereof; “alkyl” means a straight or branched chain, saturated monovalent hydrocarbon group; “alkylene” means a straight or branched chain, saturated, divalent hydrocarbon group; “alkylidene” means a straight or branched chain, saturated divalent hydrocarbon group, with both valences on a single common carbon atom; “alkenyl” means a straight or branched chain monovalent hydrocarbon group having at least two carbons joined by a carbon-carbon double bond; “cycloalkyl” means a non-aromatic monovalent monocyclic or multicyclic hydrocarbon group having at least three carbon atoms, “cycloalkenyl” means a non-aromatic cyclic divalent hydrocarbon group having at least three carbon atoms, with at least one degree of unsaturation; “aryl” and “arylene” mean a monovalent group and divalent group respectively containing at least one aromatic ring and optionally a nonaromatic ring, and having only carbon in the ring or rings; “alkylaryl” means an aryl group that has been substituted with an alkyl group; “arylalkyl” means an alkyl group that has been substituted with an aryl group; “heteroaryl” and “heteroarylene” mean a monovalent group and divalent aromatic group respectively wherein at least one carbon in a ring is replaced by a heteroatom (S, O, P, or N); “acyl” means an alkyl group attached through a carbonyl carbon bridge (—C(═O)—); “alkoxy” means an alkyl group attached through an oxygen bridge (—O—); and “aryloxy” means an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. Combinations of substituents or variables are permissible. “Substituted” as used herein means that at least one hydrogen on the designated atom or group is replaced with another group, provided that the designated atom's normal valence is not exceeded. When the substituent is oxo (═O), then two hydrogens on the atom are replaced. Exemplary groups that can be present on a “substituted” position include, but are not limited to, cyano; hydroxyl; nitro; alkanoyl (e.g., C₂₋₆ alkanoyl group such as acyl); carboxamido; C₁₋₆ or C₁₋₃ alkyl, cycloalkyl, alkenyl, and alkynyl; C₁₋₆ or C₁₋₃ alkoxy; C₆₋₁₀ aryloxy; C₁₋₆ alkylthio; C₁₋₆ or C₁₋₃ alkylsulfinyl; C₁₋₆ or C₁₋₃ alkylsulfonyl; amino di(C₁₋₆ or C₁₋₃)alkyl; C₆₋₁₂ aryl; C₇₋₁₉ arylalkyl; or C₇₋₁₉ arylalkoxy. When a group is substituted, the indicated number of carbon atoms does not include the carbon atoms, if any, of the substituent group(s).

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic polyimide, comprising:
1 to 100 mol % of repeating units of formula (1), based on 100 mol % of total repeating units of the polyimide: 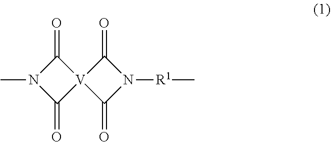
wherein
each V is independently a group of formulae: 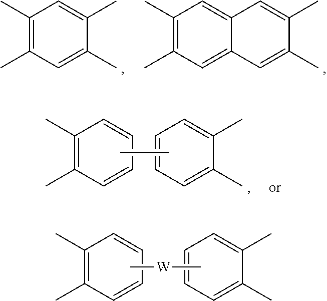
wherein W is —O—, —S—, —C(O)—, —SO₂—, —SO—, —P(R^{c})(═O)— wherein R^{c} is a C₁₋₈ alkyl or C₆₋₁₂ aryl, —C_{y}H_{2y}— wherein y is an integer from 1 to 5 or a halogenated derivative thereof, or a group of the formula —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded; and
each R¹ is independently a divalent group of formula (3): 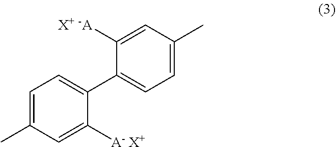
wherein
A is anionic, and each A is independently —O, —S, —S(O)₂, —S(O)₂O, —OS(O)₂O, —OP(O)(OR^{d})O, —P(O)(R^{e})O, —P(O)(OR^{f})O, or —OP(O)(R^{g})O;
X is cationic, and each X is independently Li, Na, K, Cs, Mg, Ca, Sr, Cr, Mn, Fe, Co, Ni, Cu, Ag, Zn, Cd, B, Al, Ga, In, Ge, Sn, Pb, As, Sb, phosphonium, imidazolium, guanidinium, or pyridinium, and
R^{d}, R^{e}, R^{f}, and R^{g} are each independently hydrogen, substituted or unsubstituted C₁₋₈ alkyl, or substituted or unsubstituted C₆₋₁₂ aryl,
optionally, wherein the polyimide comprises at least one endcap derived from an endcapping agent.

2. The thermoplastic polyimide of claim 1, wherein the thermoplastic polyimide further comprises 1 to 99 mol % of repeating units of formula (2), based on 100 mol % of total repeating units of the thermoplastic polyimide: 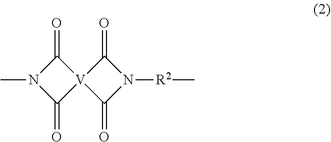
wherein
each V is independently a tetravalent C₄₋₄₀ hydrocarbon group, optionally comprising 1 to 3 heteroatoms;
each R² is independently a C₁₋₃₀ divalent hydrocarbon group, optionally comprising 1 to 4 heteroatoms; and
wherein each V in the repeating units of formula (1) is the same as or different than each V in the repeating units of formula (2).

3. The thermoplastic polyimide of claim 2, wherein each V is independently a group of formulae: 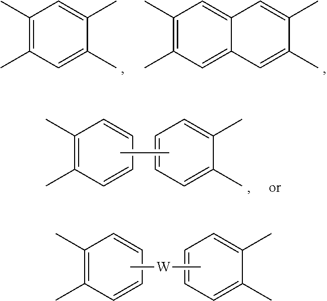
wherein W is —O—, —S—, —C(O)—, —SO₂—, —SO—, —P(R^{c})(═O)— wherein R^{c} is a C₁₋₈ alkyl or C₆₋₁₂ aryl, —C_{y}H_{2y}— wherein y is an integer from 1 to 5 or a halogenated derivative thereof, or a group of the formula —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded.

4. The thermoplastic polyimide of claim 1, wherein the thermoplastic polyimide comprises repeating units of formulae (1a) and (2a): 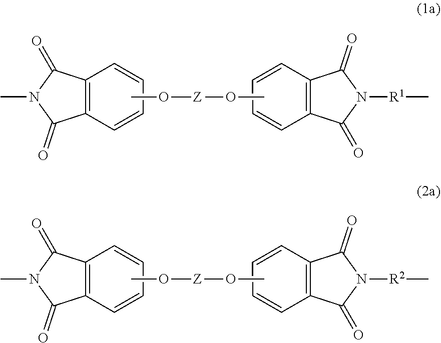
wherein each Z is independently an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded; and R¹ and R² are as defined in claim 1 or 2.

5. The thermoplastic polyimide of claim 3, wherein each Z is independently derived from a dihydroxy compound of formula (4): 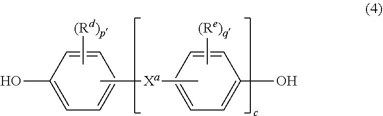
wherein each R^{d} and R^{e} is independently a halogen atom or a monovalent C₁₋₆ alkyl group, p′ and q′ are each independently integers of 0 to 4; c is 0 to 4; and X^{a} is a divalent bridging group;
or wherein each Z is independently a divalent group of formula (4a): 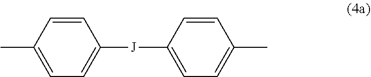
wherein J is —O—, —S—, —C(O)—, —SO₂—, —SO—, or —C_{y}H_{2y}— wherein y is an integer from 1 to 5 or a halogenated derivative thereof.

6. The thermoplastic polyimide of claim 1, wherein each R² is independently a C₆₋₃₀ aromatic hydrocarbon group or a halogenated derivative thereof, a straight or branched chain C₂₋₂₀ alkylene group or a halogenated derivative thereof, or a C₃₋₈ cycloalkylene group or halogenated derivative thereof;
or wherein each R² is independently a divalent group of formulae: 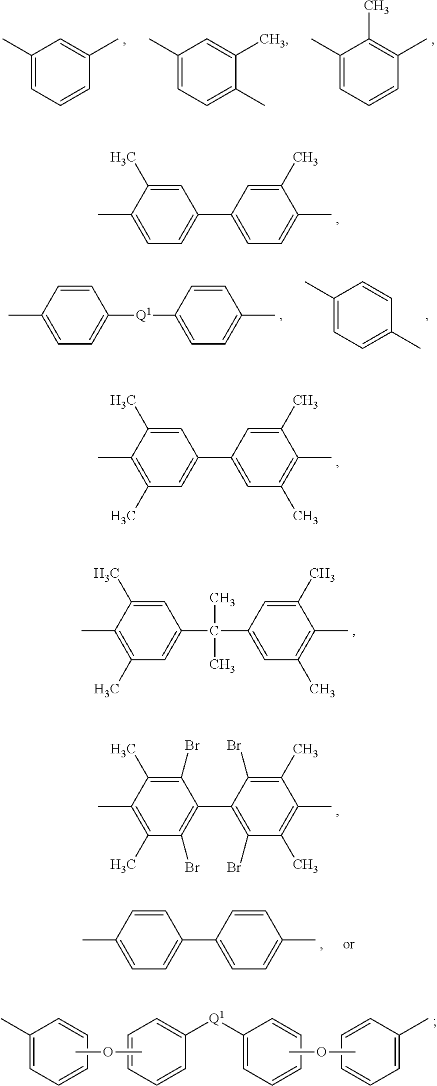
wherein,
Q¹ is —O—, —S—, —C(O)—, —SO₂—, —SO—, —P(R^{k})(═O)—, —C_{y}H_{2y}— or a halogenated derivative thereof, or —(C₆H₁₀)_{z}—,
R^{k} is a C₁₋₈ alkyl or C₆₋₁₂ aryl,
y is an integer from 1 to 5, and
z is an integer from 1 to 4;
or wherein each R² is independently meta-phenylene, para-phenylene, bis(4,4′-phenylene)sulfone, bis(3,4′-phenylene)sulfone, or bis(3,3′-phenylene)sulfone.

7. The thermoplastic polyimide of claim 1, wherein each R¹ is independently a group represented by formula (3a): 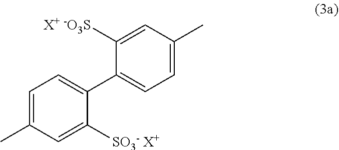
wherein each X is Li, Na, K, Cs, Mg, Ca, Sr, Zn, phosphonium, imidazolium, guanidinium, pyridinium, or a combination thereof;
or wherein X is Li, Na, K, Cs, or a combination thereof.

8. The thermoplastic polyimide of claim 1, wherein the thermoplastic polyimide has one or more of:
an inherent viscosity of 1.6 to 3.0 dL/g, or 1.7 to 2.9 dL/g, or 1.75 to 2.8 dL/g, as determined by flow rheology in dimethyl sulfoxide solution at a concentration of 0.5 g/dL at 30° C.; or
a glass transition temperature of greater than 200° C., or 200 to 400° C., or 220 to 400° C., or 220 to 360° C., as determined by differential scanning calorimetry; or
a thermal decomposition temperature of greater than 450° C., or 450 to 500° C., or 460 to 500° C., as determined at a 5% weight loss by thermogravimetric analysis; or
a water uptake of 1 to 50 wt %, or 1.5 to 40 wt %, or 2 to 40 wt %, or 5 to 40 wt %, or 10 to 40 wt %, as determined from the difference in the weight of the thermoplastic polyimide before and after exposure to 95% relative humidity at 25° C. for 24 hours; or
an ionic conductivity of greater than 5×10⁻⁸ Siemens per inverse centimeter (S/cm⁻¹), or greater than 7×10⁻⁸ S/cm⁻¹, or greater than 1×10⁻⁷ S/cm⁻¹, or greater than 9×10⁻⁸ S/cm⁻¹ to 1×10⁻⁶ S/cm⁻¹, or greater than 1×10⁻⁷ S/cm⁻¹ to 1×10⁻⁶ S/cm⁻¹, or greater than 2×10⁻⁷ S/cm⁻¹ to 1×10⁻⁶ S/cm⁻¹, or greater than 3×10⁻⁷ S/cm⁻¹ to 1×10⁻⁶ S/cm⁻¹, or greater than 4×10⁻⁷ S/cm⁻¹ to 1×10⁻⁶ S/cm⁻¹.

9. The thermoplastic polyimide of claim 1, wherein
the thermoplastic polyimide has a glass transition temperature that is greater than a glass transition temperature of comparable thermoplastic polyimide having a same number of repeating units of formula (1) wherein X is hydrogen;
the thermoplastic polyimide has a water uptake that is greater than a water uptake of a comparable thermoplastic polyimide having a same number of repeating units of formula (1) wherein X is hydrogen, as determined from the difference in the weight of the thermoplastic polyimide before and after exposure to 95% relative humidity at 25° C. for 24 hours; or
a combination thereof.

10. A method for the manufacture of the thermoplastic polyimide of claim 1, wherein the thermoplastic polyimide is a thermoplastic polyimide copolymer, the method comprising reacting:
a dianhydride of formula (5): 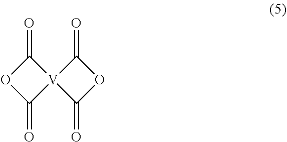
or a chemical equivalent thereof, with a diamine of formula (6):
H₂N—R¹—NH₂ (6)
and, optionally, a diamine of formula (7):
H₂N—R²—NH₂ (7)
in a solvent and under conditions effective to provide the thermoplastic polyimide,
and
wherein each V in the repeating units of formula (5) is the same as each V in the repeating units of formula (1).

11. A method for the manufacture of the thermoplastic polyimide of claim 3, wherein the thermoplastic polyimide is a polyetherimide, the method comprising reacting:
a dianhydride of formula (5a): 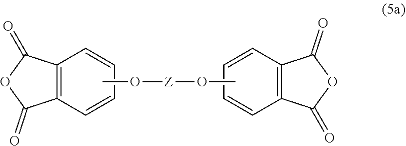
with a diamine of formula (6):
H₂N—R¹—NH₂ (6)
and, optionally, a diamine of formula (7):
H₂N—R²—NH₂ (7)
in a solvent and under conditions effective to provide the polyetherimide, and
wherein each Z in the repeating units of formula (5a) is the same as each Z in the repeating units of formula (2a).

12. The method of claim 10, further comprising:
reacting the dianhydride of formula (5) or (5a) with the diamine of formula (6) and optionally the diamine of formula (7) in a solvent and under conditions effective to provide an anhydride-capped oligomer; and
reacting an anhydride-capped oligomer with an amino compound of formula (8) under conditions effective to provide the thermoplastic polyimide of claim,
H₂N-D-A (8)
wherein,
D is substituted or unsubstituted C₁₋₂₀ alkylene, substituted or unsubstituted C₃₋₈ cycloalkylene, substituted or unsubstituted C₆₋₂₀ arylene, or substituted or unsubstituted C₃₋₁₂ heteroarylene; and
A is an anion.

13. A poly(amic acid) solution, comprising:
1 to 99 weight percent of a poly(amic acid) derived from the dianhydride of formula (5), the diamine of formula (6), and optionally the diamine of formula (7); and
a solvent,
wherein the dianhydride of formula (5), the diamine of formula (6), and the diamine of formula (7) are as defined in claim 1.

14. A polymer composition, comprising:
the thermoplastic polyimide of claim 1; and
a second polyimide different from the polyimide, wherein the second polyimide comprises repeating units represented by formula (2′): 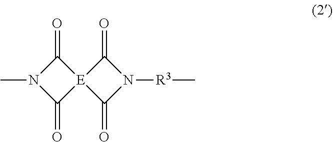
wherein
each E is independently a tetravalent C₄₋₄₀ hydrocarbon group, optionally comprising 1 to 3 heteroatoms, and
each R³ is independently a C₁₋₃₀ divalent hydrocarbon group, optionally comprising 1 to 4 heteroatoms.

15. An article comprising the polyimide of claim 1.

16. The article of claim 15, wherein the article is a film, a membrane, a fiber, a foam, a sheet, a conductive part, a coating, a preform, a composite, a varnish, or a lens;
or wherein the article is an open cell foam, a closed cell foam, a nano-foam, a battery separator, an ion exchange membrane, tubing, a capillary, an anti-static coating, a self-cleaning surface, an anti-fouling surface, or a scratch resistant part;
or wherein the article is a separator for a secondary battery.
